(19) United States
(12) Patent Application Publication
(10) Pub. No.: US 2019/0243361 A1
(43) Pub. Date: Aug. 8, 2019

(54) DRIVE SWITCHING DETERMINATION APPARATUS, DRIVE SWITCHING DETERMINATION METHOD, AND PROGRAM FOR DRIVE SWITCHING DETERMINATION

(71) Applicant: OMRON Corporation, Kyoto-shi (JP)

(72) Inventors: Tomohiro YABUUCHI, Kyoto-shi (JP); Tomoyoshi AIZAWA, Kyoto-shi (JP); Madoka WATANABE, Nara-shi (JP)

(73) Assignee: OMRON Corporation, Kyoto-shi (JP)

(21) Appl. No.: 16/384,993

(22) Filed: Apr. 16, 2019

Related U.S. Application Data
(63) Continuation of application No. PCT/JP2017/033145, filed on Sep. 13, 2017.

(30) Foreign Application Priority Data
Mar. 14, 2017 (JP) 2017-048196

(51) Int. Cl. G05D 1/00; G05D 1/02; G08G 1/0965

(52) U.S. Cl. CPC G05D 1/0061; G05D 2201/0213; G08G 1/0965; G05D 1/0287

(57) ABSTRACT

A drive switching determination apparatus for a vehicle that communicates with at least one nearby vehicle within a predetermined area includes an information notification unit that notifies the at least one nearby vehicle of a switch request to enable a manual drive mode in the vehicle, an information obtaining unit that obtains a response from the at least one nearby vehicle to the switch request, a switching determination unit that permits switching from an automatic drive mode to the manual drive mode in the vehicle based on the response from the at least one nearby vehicle, and a signal output unit that outputs a signal indicating the switching permission.

### CROSS REFERENCE TO RELATED APPLICATIONS

This application is a continuation application of International Application No. PCT/JP2017/033145, filed on Sep. 13, 2017, which claims priority based on the Article 8 of Patent Cooperation Treaty from prior Japanese Patent Application No. 2017-048196, filed on Mar. 14, 2017, the entire contents of which are incorporated herein by reference.

### FIELD

The disclosure relates to a drive switching determination apparatus, a drive switching determination method, and a program for drive switching determination for determining switching from an automatic drive mode to a manual drive mode.

### BACKGROUND

Automatic drive modes have been developed to allow a vehicle to travel along a predefined route without a driving operation performed by a driver. Various techniques have also been developed for shifting from an automatic drive mode to a manual drive mode.

For example, one technique includes determining whether automatic driving can shift to manual driving at a defined shifting point. When automatic driving can shift to manual driving, the technique terminates the automatic drive control. When automatic driving cannot shift to manual driving, the technique controls the vehicle to stop in a parking area (See Japanese Patent No. 4985103).

To enable real automatic driving, techniques are being developed for stopping an automated vehicle within a predetermined area before shifting from automatic driving to manual driving. To ensure safety, the vehicle is stopped before the drive mode is shifted from the automatic drive mode to the manual drive mode. However, multiple vehicles stopped in a predetermined area may switch from the automatic drive mode to the manual drive mode at almost the same time. Such vehicles may then become ready to start at each driver's timing, and may disable smooth traveling. Techniques are thus to be developed for allowing smooth traveling while achieving safety.

### SUMMARY

In response to this, one or more aspects are directed to a drive switching determination apparatus, a drive switching determination method, and a program for drive switching determination that allows smooth traveling after switching from an automatic drive mode to a manual drive mode.

In response to the above issue, a drive switching determination apparatus according to a first aspect is for a vehicle that communicates with at least one nearby vehicle within a predetermined area. The apparatus includes an information notification unit that notifies the at least one nearby vehicle of a switch request to enable a manual drive mode in the vehicle, an information obtaining unit that obtains a response from the at least one nearby vehicle to the switch request, a switching determination unit that permits switching from an automatic drive mode to the manual drive mode in the vehicle based on the response from the at least one nearby vehicle, and a signal output unit that outputs a signal indicating the switching permission.

A drive switching determination apparatus according to a second aspect is the drive switching determination apparatus according to a first aspect in which the information obtaining unit obtains the response including switch permission or switch prohibition of switching from the automatic drive mode to the manual drive mode in the vehicle.

A drive switching determination apparatus according to a third aspect is the drive switching determination apparatus according to a first aspect in which the information obtaining unit obtains the response including information about a switch request to enable a manual drive mode in the at least one nearby vehicle, and the switching determination unit permits switching from the automatic drive mode to the manual drive mode in the vehicle based on timing of the switch request from the vehicle and timing of the switch request from the at least one nearby vehicle.

A drive switching determination apparatus according to a fourth aspect is the drive switching determination apparatus according to a first aspect in which the information obtaining unit obtains the response including a stop time of the at least one nearby vehicle that is stopped, and the switching determination unit permits switching from the automatic drive mode to the manual drive mode in the vehicle based on a stop time of the vehicle and the stop time of the at least one nearby vehicle.

A drive switching determination apparatus according to a fifth aspect is the drive switching determination apparatus according to a first aspect in which the information obtaining unit obtains the response including positional information about the at least one nearby vehicle that is stopped, and the switching determination unit permits switching from the automatic drive mode to the manual drive mode in the vehicle based on positional information about the vehicle and the positional information about the at least one nearby vehicle.

A drive switching determination apparatus according to a sixth aspect is the drive switching determination apparatus according to a first aspect in which the information obtaining unit obtains the response including positional information and a traveling direction of the at least one nearby vehicle that is stopped, and the switching determination unit permits switching from the automatic drive mode to the manual drive mode in the vehicle based on positional information and a traveling direction of the vehicle and the positional information and the traveling direction of the at least one nearby vehicle.

A drive switching determination apparatus according to a seventh aspect is the drive switching determination apparatus according to any one of third to sixth aspects in which the switching determination unit determines whether to permit switching from the automatic drive mode to the manual drive mode in the vehicle based on a comparison between a priority of switching from the automatic drive mode to the manual drive mode in the vehicle and a priority of switching from the automatic drive mode to the manual drive mode in the at least one nearby vehicle, where the priority in the at least one nearby vehicle is determined based on the response from the at least one nearby vehicle.

A drive switching determination apparatus according to an eighth aspect is the drive switching determination apparatus according to any one of first to seventh aspects in which the information notification unit transmits the switch request when the vehicle is stopped.

A drive switching determination apparatus according to a ninth aspect is the drive switching determination apparatus according to any one of first to eighth aspects in which the switch request is a request for switching from the automatic drive mode to the manual drive mode.

A drive switching determination method according to a tenth aspect is for a vehicle that communicates with at least one nearby vehicle within a predetermined area. The method includes notifying the at least one nearby vehicle of a switch request to enable a manual drive mode in the vehicle, obtaining a response from the at least one nearby vehicle to the switch request, determining whether to permit switching from an automatic drive mode to the manual drive mode in the vehicle based on the response from the at least one nearby vehicle, and outputting a signal indicating the switching permission.

A program for drive switching determination according to an eleventh aspect causes a computer to function as the units included in the drive switching determination apparatus according to any one of first to ninth aspects.

The drive switching determination apparatus according to a first aspect for a vehicle that communicates with at least one nearby vehicle within a predetermined area notifies the nearby vehicle of a switch request for switching from the automatic drive mode to the manual drive mode in the vehicle, and permits switching from the automatic drive mode to the manual drive mode in the vehicle based on a response from the nearby vehicle. More specifically, the vehicle is allowed to switch based on the state of the nearby vehicle indicated by the response. The vehicle thus switches from the automatic drive mode to the manual drive mode and then starts depending on the driver's timing, allowing smooth traveling and achieving safety within the predetermined area. For example, vehicles within a predetermined area are prevented from switching from the automatic drive mode to the manual drive mode depending on their timing and starting depending on their timing.

The drive switching determination apparatus according to a second aspect permits switching from the automatic drive mode to the manual drive mode based on the response including switch permission to enable the manual drive mode from the nearby vehicle, or does not permit the switching based on the response including switch prohibition. The vehicle that has obtained switch permission from the nearby vehicle is ready to enable the manual drive mode and start in the manual drive mode, whereas the vehicle that has obtained switch prohibition is not yet ready to enable the manual drive mode. Such switching determination allows smooth traveling and achieves safety within the predetermined area.

In the apparatus according to a third aspect, the manual drive mode is permitted based on the timing of a switch request to enable the manual drive mode from each vehicle within the predetermined area. For example, the vehicle with the earliest request for switch permission may receive the switch permission. The vehicle that has transmitted the earliest request for switch permission within the predetermined area is ready to switch from the automatic drive mode to the manual drive mode and start depending on the driver's timing. The other vehicles are not yet to enable the manual drive mode (being in a queue for enabling the manual drive mode). Such switching determination allows smooth vehicle traveling and achieves safety within the predetermined area.

In the apparatus according to a fourth aspect, the manual drive mode is permitted based on the stop time of each vehicle within the predetermined area. For example, the vehicle that has stopped earliest may receive the permission to enable the manual drive mode. The vehicle that has stopped earliest within the predetermined area is ready to switch from the automatic drive mode to the manual drive mode and start depending on the driver's timing. The other vehicles are not yet to enable the manual drive mode (being in a queue for enabling the manual drive mode). Such switching determination allows smooth vehicle traveling and achieves safety within the predetermined area.

In the apparatus according to a fifth aspect, the manual drive mode is permitted based on the positional information about each vehicle within the predetermined area. For example, the vehicle nearest a reference position within the predetermined area may receive the permission to enable the manual drive mode. The vehicle nearest the reference position within the predetermined area is ready to switch from the automatic drive mode to the manual drive mode and start depending on the driver's timing. The other vehicles are not yet to enable the manual drive mode (being in a queue for enabling the manual drive mode). Such switching determination allows smooth vehicle traveling and achieves safety within the predetermined area.

In the apparatus according to a sixth aspect, the manual drive mode is permitted based on the positional information and the traveling direction of each vehicle within the predetermined area. For example, the vehicle having no vehicles ahead in the traveling direction and nearest a reference position within the predetermined area may receive the switch permission. The vehicle having no vehicles ahead in the traveling direction and nearest the reference position within the predetermined area is ready to switch from the automatic drive mode to the manual drive mode and start depending on the driver's timing. The other vehicles are not yet to enable the manual drive mode (being in a queue for enabling the manual drive mode). Such switching determination allows smooth vehicle traveling and achieves safety within the predetermined area.

The apparatus according to a seventh aspect determines whether to permit the switching in each vehicle based on the priority of switching from the automatic drive mode to the manual drive mode in each vehicle within the predetermined area. Such switching determination allows smooth vehicle traveling and achieves safety within the predetermined area.

The apparatus according to an eighth aspect transmits a switch request to switch from the automatic drive mode to the manual drive mode after the vehicle stops within the predetermined area. Based on the responses from nearby vehicles, the apparatus permits switching from the automatic drive mode to the manual drive mode in the vehicle. Such switching determination allows smooth vehicle traveling and achieves safety at the restart of a vehicle stopped within the predetermined area.

The apparatus according to a ninth aspect notifies nearby vehicles of a switch request for switching from the automatic drive mode to the manual drive mode, and determines the switching based on the responses from the nearby vehicles. Such switching determination allows smooth vehicle traveling and achieves safety after switching from the automatic drive mode to the manual drive mode within the predetermined area.

The drive switching determination method according to a tenth aspect can achieve the same advantageous effects as the drive switching determination apparatus according to a first aspect. More specifically, the drive switching determination method allows smooth vehicle traveling and achieves safety within the predetermined area.

The program for drive switching determination according to an eleventh aspect can achieve the same advantageous effects as the drive switching determination apparatus according to first to ninth aspects. More specifically, the program for drive switching determination allows smooth vehicle traveling and achieves safety within the predetermined area.

### BRIEF DESCRIPTION OF THE DRAWINGS

FIG. 1 is a schematic diagram illustrating a vehicle including a drive switching determination apparatus according to one or more embodiments.

FIG. 2 is a block diagram illustrating a drive switching determination apparatus according to one or more embodiments.

FIG. 3 is a flow diagram illustrating an example of the entire procedure of switching determination performed by a drive switching determination apparatus according to one or more embodiments.

FIG. 4 is a flow diagram illustrating an example of a switching determination performed by a drive switching determination apparatus according to one or more embodiments.

FIG. 5 is a diagram illustrating an example of providing manual drive mode permission to a vehicle that has stopped earliest among multiple vehicles within a predetermined area.

FIG. 6 is a diagram illustrating an example of providing manual drive mode permission to a vehicle nearest a reference position among multiple vehicles within a predetermined area.

FIG. 7 is a diagram illustrating an example of providing manual drive mode permission to a vehicle with no vehicle ahead in a traveling direction and nearest a reference position among multiple vehicles within a predetermined area.

### DETAILED DESCRIPTION

### Embodiments

One or more embodiments will now be described with reference to the drawings.

### Embodiment

### Structure

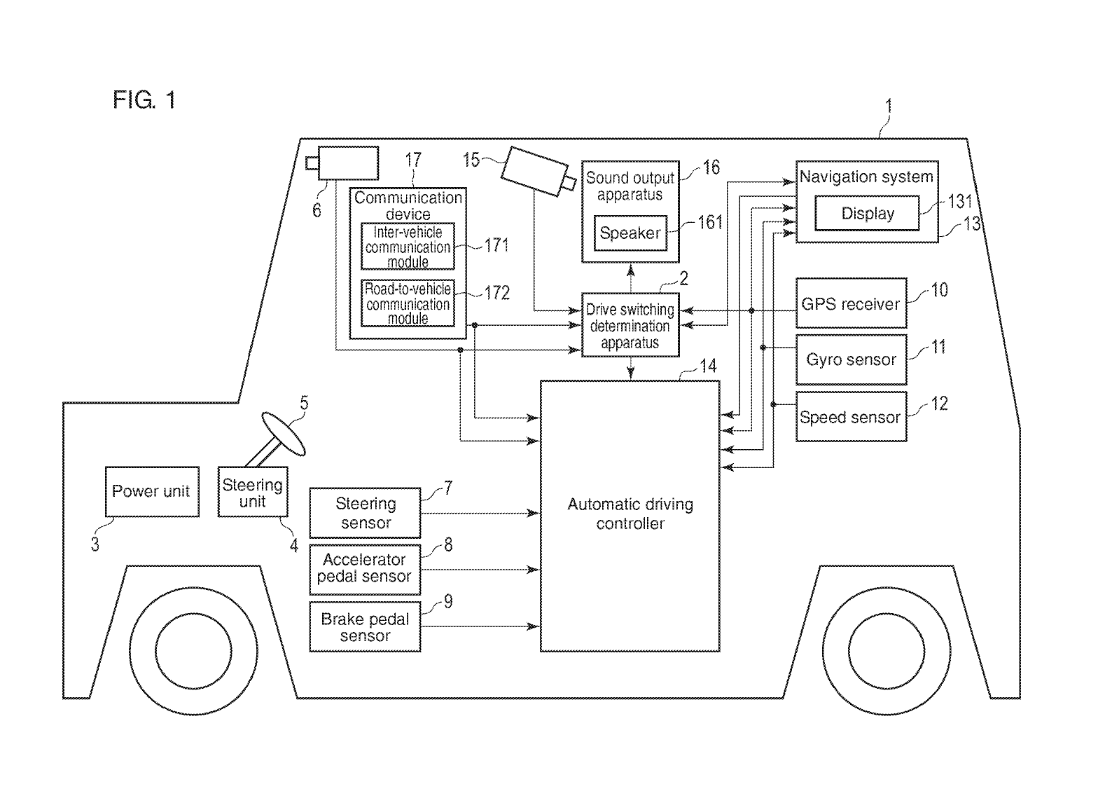

FIG. 1 is a schematic diagram of a vehicle 1 including a drive switching determination apparatus 2 according to one or more embodiments. The drive switching determination apparatus 2 is incorporated in the vehicle 1, such as an automobile. The structure of the drive switching determination apparatus 2 will be described later. The vehicle 1 may be any of, for example, an automobile, a bus, a truck, and a train or may be any other vehicle drivable by a driver.

The vehicle 1 includes, as its basic components, a power unit 3 including a power supply and a transmission, and a steering unit 4 including a steering wheel 5. The vehicle 1 has two drive modes, a manual drive mode and an automatic drive mode. The power supply includes an engine, a motor, or both.

The manual drive mode allows the vehicle 1 to travel mainly based on, for example, a manual driving operation performed by a driver. For example, the manual drive mode includes a vehicle driving operation mode for driving a vehicle 1 with a driving operation performed by a driver alone, and an assisted driving mode for driving a vehicle 1 mainly with a driving operation performed by a driver in combination with assisted driving.

For example, when the vehicle 1 travels along a curve, assisted driving assists the driver with the steering torque to achieve an appropriate steering quantity based on the curvature of the curve. Assisted driving further includes control for assisting the driver's acceleration (e.g., accelerator pedal operation) or braking (e.g., brake pedal operation), manual steering (manual steering during driving), and manual speed regulation (manual speed control during driving). Manual steering refers to steering the vehicle 1 mainly with the driver's operation on the steering wheel 5. Manual speed regulation refers to adjusting the speed of the vehicle 1 mainly with the driver's accelerating operation or braking operation.

Assisted driving excludes control for forcibly interrupting the driver's driving operation for automatically driving the vehicle 1. In other words, the manual drive mode reflects the driver's operation on the traveling vehicle 1 within a predetermined allowable range, but excludes any control for forcibly interrupting the vehicle 1 traveling under predetermined conditions (e.g., deviation of the vehicle 1 from a lane).

In contrast, the automatic drive mode enables automatic driving of a vehicle 1 along a road on which the vehicle 1 is traveling. The automatic drive mode includes automatic driving of a vehicle 1 to a predetermined destination without the driver performing a driving operation. The automatic drive mode is not limited to complete automatic control of the vehicle 1, and includes driving that reflects the driver's operation in the traveling vehicle 1 within a predetermined allowable range. In other words, the automatic drive mode includes control for forcibly interrupting the vehicle 1 travelling under predetermined conditions while reflecting the driver's operation on the traveling vehicle 1 within a predetermined allowable range.

The vehicle 1 further includes an exterior view camera 6, a steering sensor 7, an accelerator pedal sensor 8, a brake pedal sensor 9, a global positioning system (GPS) receiver 10, a gyro sensor 11, a speed sensor 12, a navigation system 13, an automatic driving controller 14, a driver camera 15, a sound output apparatus 16, and a communication device 17.

The exterior view camera 6 is installed at a given position of the vehicle 1 to capture an image outside the vehicle 1. Although FIG. 1 shows the single exterior view camera 6, the vehicle 1 may include multiple exterior view cameras for capturing images in different directions. The exterior view camera 6 constantly captures images of the traveling environment near the vehicle 1. The exterior view camera 6 is activated in response to the start of driving of the vehicle 1 and constantly captures images outside the vehicle 1. The exterior view camera 6 is an example of a sensor for monitoring the external environment of the vehicle 1. The exterior view camera 6 outputs the captured images (hereafter, exterior image data) to the drive switching determination apparatus 2 and the automatic driving controller 14.

The steering sensor 7 detects a steering angle. The steering sensor 7 outputs the detection result to the automatic driving controller 14. The accelerator pedal sensor 8 detects the operational quantity of an accelerator pedal. The accelerator pedal sensor 8 outputs the detection result to the automatic driving controller 14. The brake pedal sensor 9 detects the operational quantity of a brake pedal. The brake pedal sensor 9 outputs the detection result to the automatic driving controller 14. The GPS receiver 10 receives information indicating the current position of the vehicle 1. The GPS receiver 10 outputs the current positional information to the drive switching determination apparatus 2, the navigation system 13, and the automatic driving controller 14. The gyro sensor 11 detects the behavior of the vehicle 1. The gyro sensor 11 outputs the detection result to the automatic driving controller 14. The speed sensor 12 detects the speed of the vehicle 1. The speed sensor 12 outputs the detection result to the automatic driving controller 14.

The navigation system 13 is an example of an image display device including a display 131 for displaying an image. The navigation system 13 stores map information. The navigation system 13 uses information about a destination input by, for example, the driver, map information, and the current positional information from the GPS receiver 10 to extract information about routes from the current position to the destination. The navigation system 13 displays the route information on the display 131. The navigation system 13 may also display information other than the route information on the display 131. The navigation system 13 also uses information about a predetermined area included in the map information and the current positional information from the GPS receiver 10 to determine whether the vehicle 1 is traveling or stopped within the predetermined area. For example, the predetermined area allows a temporary stop for switching from the automatic drive mode to the manual drive mode.

The navigation system 13 outputs the route information to the drive switching determination apparatus 2 and the automatic driving controller 14.

The route information may also include road environmental information in addition to the information about the routes from the current position to the destination. For example, the road environmental information is information about the predetermined area for switching from the automatic drive mode to the manual drive mode. The structure of the automatic driving controller 14 will now be described.

The automatic driving controller 14 automatically controls the traveling of the vehicle 1 in the automatic drive mode. The automatic driving controller 14 obtains the exterior image data from the exterior view camera 6, the detection result from the steering sensor 7, the detection result from the accelerator pedal sensor 8, the detection result from the brake pedal sensor 9, the current positional information from the GPS receiver 10, the detection result from the gyro sensor 11, the detection result from the speed sensor 12, and the route information from the navigation system 13. The automatic driving controller 14 automatically controls the traveling of the vehicle 1 based on, for example, these items of information and traffic information obtained through road-to-vehicle communication by the communication device 17 described later.

The automatic control includes autosteering (automatic steering during driving) and automatic speed regulation (automatic speed regulation during driving). Autosteering enables a driving state in which the steering unit 4 is controlled automatically. Autosteering includes lane keeping assist system (LKAS). LKAS automatically controls the steering unit 4 to prevent the vehicle 1 from leaving the driving lane when, for example, the driver is not performing a steering operation. During the operation of LKAS, the steering operation of the driver may be reflected in the vehicle 1 steering within the range in which the vehicle 1 stays in the driving lane (allowable range). Autosteering is not limited to LKAS.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle. During the operation of ACC, the automatic driving controller 14 decelerates the vehicle 1 in response to the driver's braking (e.g., brake pedal operation), or may accelerate the vehicle 1 in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC) that performs constant speed control alone.

The structure of the driver camera 15 will now be described. The driver camera 15 is installed in front of the driver, for example, on a dashboard. The driver camera 15 is an example of a sensor for monitoring the driver. The driver camera 15 is activated in response to the start of driving of the vehicle 1 and constantly captures images of a predefined range including the face of the driver. The driver camera 15 outputs the captured images (hereafter, driver image data) to the drive switching determination apparatus 2. The driver image data is an example of monitoring data used to detect the state of the driver. The driver's state includes, for example, at least one of looking forward carefully, feeling drowsy, looking aside, putting on or taking off clothes, operating a phone, leaning against the window or an armrest, being interrupted in driving by a passenger or a pet, suffering a disease attack, looking back, resting the head on the arms, eating and drinking, smoking, feeling dizzy, taking abnormal movement, operating the car navigation system or the audio system, putting on or taking off glasses or sunglasses, taking a photograph, the degree of target recognition, and other indicators. The degree of target recognition is an indicator of the level at which the driver recognizes a target (e.g., by seeing it), or the degree of the driver being aware of the target (e.g., visually). The driver's state may include indicators other than these examples.

The sound output apparatus 16 includes a speaker 161. The sound output apparatus 16 outputs various items of information using sounds.

The communication device 17 includes an inter-vehicle communication module 171 and a road-to-vehicle communication module 172. The inter-vehicle communication module 171 wirelessly communicates with one or more other vehicles (e.g., nearby vehicles) in a direct manner. For example, the nearby vehicles are vehicles within a predetermined area for switching from the automatic drive mode to the manual drive mode when the vehicle 1 enters the predetermined area. The inter-vehicle communication module 171 transmits information to nearby vehicles near the vehicle 1 through inter-vehicle communication, and the information is, for example, at least one of information about the vehicle 1, a request to each nearby vehicle, and a response to each nearby vehicle. The information about the vehicle 1 includes, but not limited to, vehicle model information. In addition, the inter-vehicle communication module 171 receives information from nearby vehicles near the vehicle 1 through inter-vehicle communication, and the information is, for example, at least one of information about the nearby vehicles, a request from each nearby vehicle, and a response from each nearby vehicle. The information about the nearby vehicles includes, but not limited to, vehicle model information.

The road-to-vehicle communication module 172 wirelessly communicates with a roadside unit installed along a road. The road-to-vehicle communication module 172 transmits information such as information about the vehicle 1 to a roadside unit through road-to-vehicle communication. In addition, the road-to-vehicle communication module 172 receives various items of information described below from a roadside unit through road-to-vehicle communication. The road-to-vehicle communication module 172 may also receive, for example, information about another vehicle near the vehicle 1 from a roadside unit. The road-to-vehicle communication module 172 may also receive, for example, traffic information from a roadside unit. The traffic information may include information such as lane restriction information and information about a closed road. The traffic information may include information such as traffic signal information about traffic signal indication near the roadside unit. The road-to-vehicle communication module 172 may also receive, for example, weather information from a roadside unit. The road-to-vehicle communication module 172 may also receive, from a roadside unit, for example, information about the presence of a person crossing a road near the roadside unit. The road-to-vehicle communication module 172 may also receive information other than these items of information from a roadside unit.

The communication device 17 outputs the information obtained as described above through inter-vehicle communication and road-to-vehicle communication to the drive switching determination apparatus 2 and the automatic driving controller 14.

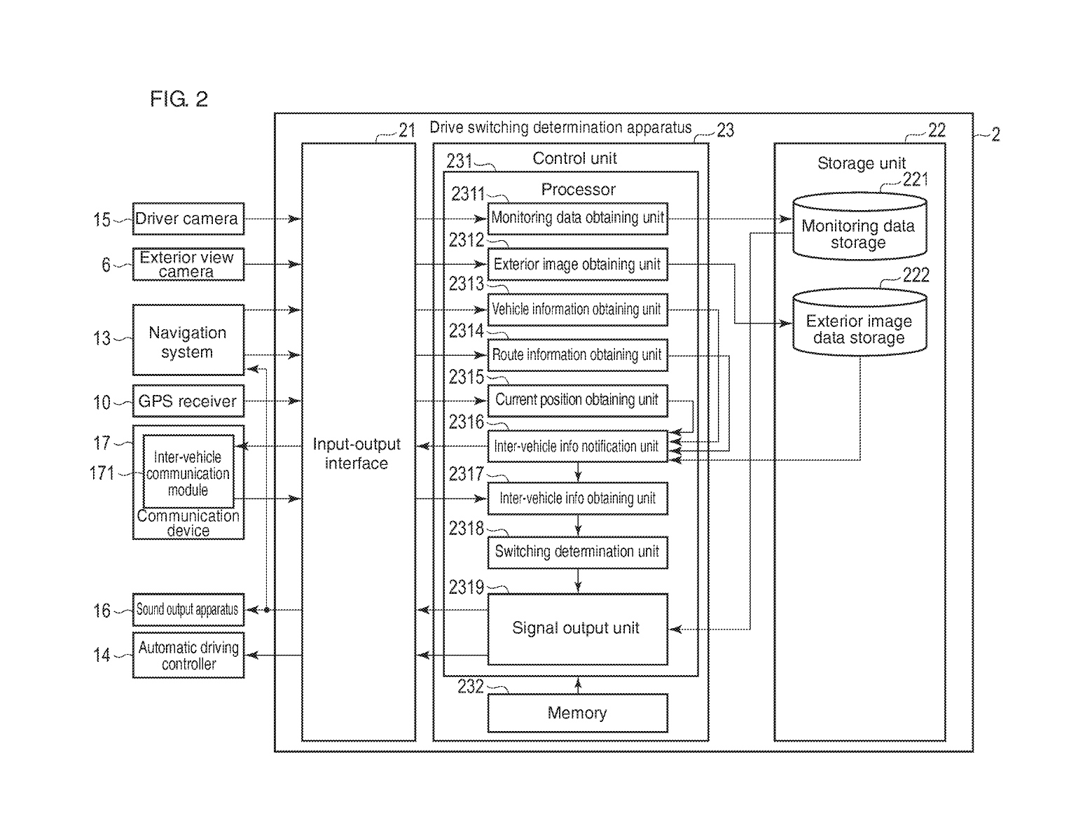

The structure of the drive switching determination apparatus 2 will now be described. The drive switching determination apparatus 2 determines the switchability of the vehicle 1 from the automatic drive mode to the manual drive mode based on the information obtained from the nearby vehicles through inter-vehicle communication. FIG. 2 is a block diagram of the drive switching determination apparatus 2 according to one or more embodiments. The drive switching determination apparatus 2 includes an input-output interface 21, a storage unit 22, and a control unit 23.

The input-output interface 21 connects the exterior view camera 6, the GPS receiver 10, the navigation system 13, the automatic driving controller 14, the driver camera 15, the sound output apparatus 16, and the communication device 17 to the control unit 23.

The structure of the storage unit 22 will now be described. For example, the storage unit 22 is a nonvolatile memory such as a solid state drive (SSD) or a hard disk drive (HDD), which is writable and readable as appropriate. The storage unit 22 includes a monitoring data storage 221 and an exterior image data storage 222.

The monitoring data storage 221 stores driver image data received by the control unit 23 from the driver camera 15. The exterior image data storage 222 stores exterior image data received by the control unit 23 from the exterior view camera 6.

The structure of the control unit 23 will now be described. The control unit 23 includes a processor 231 and a memory 232. The processor 231 is, for example, a central processing unit (CPU) included in a computer. Each component included in the processor 231 will be described later. Although FIG. 2 shows the single processor 231, the control unit 23 may include one or more processors. The memory 232 is a read-write nonvolatile memory, such as an SSD or an HDD, or a volatile memory, such as a random access memory (RAM). The memory 232 stores programs that cause the processor 231 to perform the processing of the components included in the processor 231. The programs are also instructions that cause the processor 231 to operate. The programs are stored in the storage unit 22 and read from the storage unit 22 into the memory 232. The programs in the memory 232 are read by the processor 231. The embodiment may be implemented by the programs.

Each component included in the processor 231 will now be described. The processor 231 includes a monitoring data obtaining unit 2311, an exterior image obtaining unit 2312, a vehicle information obtaining unit 2313, a route information obtaining unit 2314, a current position obtaining unit 2315, an inter-vehicle information notification unit 2316, an inter-vehicle information obtaining unit 2317, a switching determination unit 2318, and a signal output unit 2319. The units may be distributed among one or more processors.

The monitoring data obtaining unit 2311 obtains driver image data from the driver camera 15 via the input-output interface 21. The monitoring data obtaining unit 2311 stores the driver image data into the monitoring data storage 221. The exterior image obtaining unit 2312 obtains exterior image data from the exterior view camera 6 via the input-output interface 21. The exterior image obtaining unit 2312 stores the exterior image data into the exterior image data storage 222.

The vehicle information obtaining unit 2313 obtains information about the vehicle 1 from the navigation system 13 via the input-output interface 21. For example, the vehicle information obtaining unit 2313 obtains the information about whether the vehicle 1 is traveling or stopped within a predetermined area, and also the traveling direction or the stop time of the vehicle 1. The vehicle information obtaining unit 2313 outputs the information about the vehicle 1 to the inter-vehicle information notification unit 2316. The route information obtaining unit 2314 obtains route information from the navigation system 13 via the input-output interface 21. The route information obtaining unit 2314 outputs the route information to the inter-vehicle information notification unit 2316. The current position obtaining unit 2315 obtains current positional information from the GPS receiver 10 via the input-output interface 21. The current position obtaining unit 2315 outputs the current positional information to the inter-vehicle information notification unit 2316.

The inter-vehicle information notification unit 2316 communicates with one or more nearby vehicles via the input-output interface 21 and the inter-vehicle communication module 171 in the communication device 17 to provide the nearby vehicles with various items of information from the vehicle 1. For example, the inter-vehicle information notification unit 2316 notifies the nearby vehicles of a switch request to enable the manual drive mode in the vehicle 1. The switch request to enable the manual drive mode may equate to a switch request to switch the vehicle 1 from the automatic drive mode to the manual drive mode. The nearby vehicles have at least the structure of the vehicle 1. Thus, each nearby vehicle can use its inter-vehicle information notification unit 2316 to provide the vehicle 1 and the other nearby vehicles with its various items of information.

The inter-vehicle information obtaining unit 2317 communicates with one or more nearby vehicles via the input-output interface 21 and the inter-vehicle communication module 171 in the communication device 17 to obtain various items of information from the nearby vehicles. For example, the inter-vehicle information obtaining unit 2317 obtains a response from each nearby vehicle to a request from the vehicle 1 for permission to enable the manual drive mode. The nearby vehicles have at least the structure of the vehicle 1. Thus, each nearby vehicle can use its inter-vehicle information obtaining unit 2317 to obtain various items of information from the vehicle 1 and the other nearby vehicles.

The switching determination unit 2318 determines the drive mode switchability of the vehicle 1. The switching determination unit 2318 determines whether to permit switching the vehicle 1 from the automatic drive mode to the manual drive mode based on the response from each nearby vehicle. In other words, the switching determination unit 2318 determines whether to permit the manual drive mode in the vehicle 1 based on the response from each nearby vehicle.

For example, when the response from every target nearby vehicle includes permission to enable the manual drive mode in the vehicle 1, the switching determination unit 2318 permits switching the vehicle 1 from the automatic drive mode to the manual drive mode. In contrast, when the response from any target nearby vehicle includes no permission to enable the manual drive mode in the vehicle 1 or includes prohibition of the automatic drive mode, the switching determination unit 2318 does not permit switching the vehicle 1 from the automatic drive mode to the manual drive mode.

In some embodiments, the switching determination unit 2318 in the vehicle 1 may determine the drive mode switchability of the vehicle 1 by comparing the switch request to enable the manual drive mode in the vehicle 1 (timing of the switch request) and the switch request to enable the manual drive mode from every target nearby vehicle (timing of the switch request). In some embodiments, the switching determination unit 2318 in the vehicle 1 may determine the drive mode switchability of the vehicle 1 by comparing the stop time of the vehicle 1 and the stop time included in the response from every target nearby vehicle. In some embodiments, the switching determination unit 2318 in the vehicle 1 may determine the drive mode switchability of the vehicle 1 by comparing the positional information about the vehicle 1 and the positional information included in the response from every target nearby vehicle. In some embodiments, the switching determination unit 2318 in the vehicle 1 may determine the drive mode switchability of the vehicle 1 by comparing the positional information and the traveling direction of the vehicle 1 and the positional information and the traveling direction included in the response from every target nearby vehicle.

The signal output unit 2319 outputs a signal to each component via the input-output interface 21. Example signals output from the signal output unit 2319 will now be described. The signal output unit 2319 outputs a signal indicating the switching determination result to at least one of the navigation system 13 and the automatic driving controller 14. For example, in response to permission to switch from the automatic drive mode to the manual drive mode, the signal output unit 2319 may output a signal indicating the permission to switch from the automatic drive mode to the manual drive mode to the navigation system 13. The navigation system 13 then outputs information indicating that the switching is permitted from the automatic drive mode to the manual drive mode. In response to the permission to switch from the automatic drive mode to the manual drive mode, the signal output unit 2319 may also output a signal indicating the permission to switch from the automatic drive mode to the manual drive mode or a signal carrying an instruction to switch from the automatic drive mode to the manual drive mode to the automatic driving controller 14. The automatic driving controller 14 shifts to a state that allows switching from the automatic drive mode to the manual drive mode based on the signal indicating the permission to switch from the automatic drive mode to the manual drive mode. The automatic driving controller 14 also switches the drive mode from the automatic drive mode to the manual drive mode based on the signal carrying an instruction to switch from the automatic drive mode to the manual drive mode.

In response to prohibition of switching from the automatic drive mode to the manual drive mode, the signal output unit 2319 may output a signal indicating the prohibition of switching from the automatic drive mode to the manual drive mode to the navigation system 13. The navigation system 13 then outputs information indicating that the switching is not permitted from the automatic drive mode to the manual drive mode. The signal output unit 2319 may also output a signal indicating the prohibition of switching from the automatic drive mode to the manual drive mode or a signal for restricting switching from the automatic drive mode to the manual drive mode to the automatic driving controller 14. The automatic driving controller 14 shifts to a state that does not allow switching from the automatic drive mode to the manual drive mode based on the signal indicating the prohibition of switching from the automatic drive mode to the manual drive mode. The automatic driving controller 14 also disables or suspends switching from the automatic drive mode to the manual drive mode based on the signal for restricting switching from the automatic drive mode to the manual drive mode.

### Operation

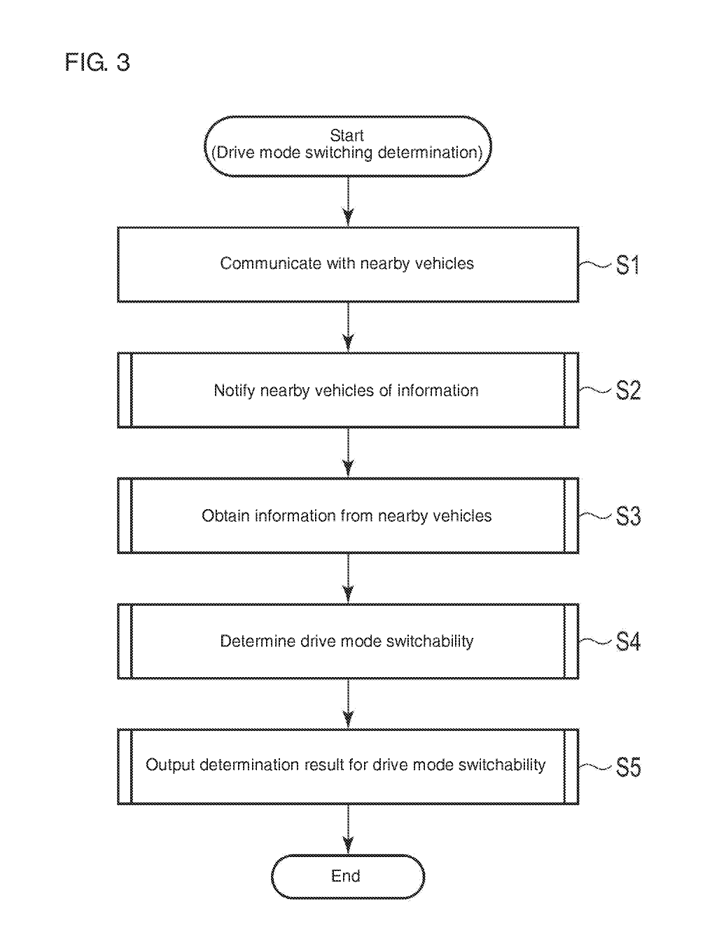

The operation of the drive switching determination apparatus 2 with the above structure will now be described. FIG. 3 is a flowchart showing an example of the entire procedure of switching determination performed by the drive switching determination apparatus 2. The control unit 23 determines whether the vehicle 1 is traveling or stopped within a predetermined area, based on the information from the vehicle information obtaining unit 2313 indicating whether the vehicle 1 is traveling or stopped within the predetermined area. The communication device 17 in the vehicle 1 within the predetermined area communicates with one or more nearby vehicles within the predetermined area (step S1). For example, the vehicle 1 and each nearby vehicle within the predetermined area may communicate with each other.

The inter-vehicle information notification unit 2316 notifies the nearby vehicle(s) within the predetermined area of information from the vehicle 1 through the communication device 17 (step S2). The inter-vehicle information obtaining unit 2317 obtains information from the nearby vehicles (step S3). The timing for the notification of the information and the timing for obtaining the information may be redesigned as appropriate. The information transmitted from the vehicle 1 and the information obtained from the nearby vehicles will be described in detail later. For example, the vehicle 1 and each nearby vehicle within the predetermined area may provide the other vehicles with information as appropriate and obtain information from the other vehicles.

The switching determination unit 2318 determines the drive mode switchability of the vehicle 1 based on the information about the vehicle 1 and the information about the nearby vehicles (step S4). For example, the vehicle 1 and nearby vehicles within the predetermined area may each determine the drive mode switchability. The determination of the drive mode switchability will be described in detail later.

The signal output unit 2319 outputs a signal indicating the switching determination result to at least one of the navigation system 13 and the automatic driving controller 14 (step S5). For example, in response to permission to switch from the automatic drive mode to the manual drive mode, the signal output unit 2319 may output a signal indicating the permission to switch from the automatic drive mode to the manual drive mode or a signal carrying an instruction to switch from the automatic drive mode to the manual drive mode to the automatic driving controller 14. For example, the vehicle 1 and nearby vehicles within the predetermined area may each output a signal indicating the switching determination result.

In response to the signals indicating the permission to switch from the automatic drive mode to the manual drive mode, the automatic driving controller 14 accepts an instruction to switch from the automatic drive mode to the manual drive mode. The instruction enables the vehicle 1 to switch from the automatic drive mode to the manual drive mode, and the vehicle 1 in the manual drive mode can start (traveling) depending on the driver's timing.

The switchability determination in step S4 provides permission to switch from the automatic drive mode to the manual drive mode to a particular vehicle among the vehicle 1 and the nearby vehicles within the predetermined area. The switchability determination will be described in detail later. The permission enables the particular vehicle to switch from the automatic drive mode to the manual drive mode and then start depending on the driver's timing. This process thus prevents the vehicle 1 and each nearby vehicle within the predetermined area from randomly starting depending on their timing.

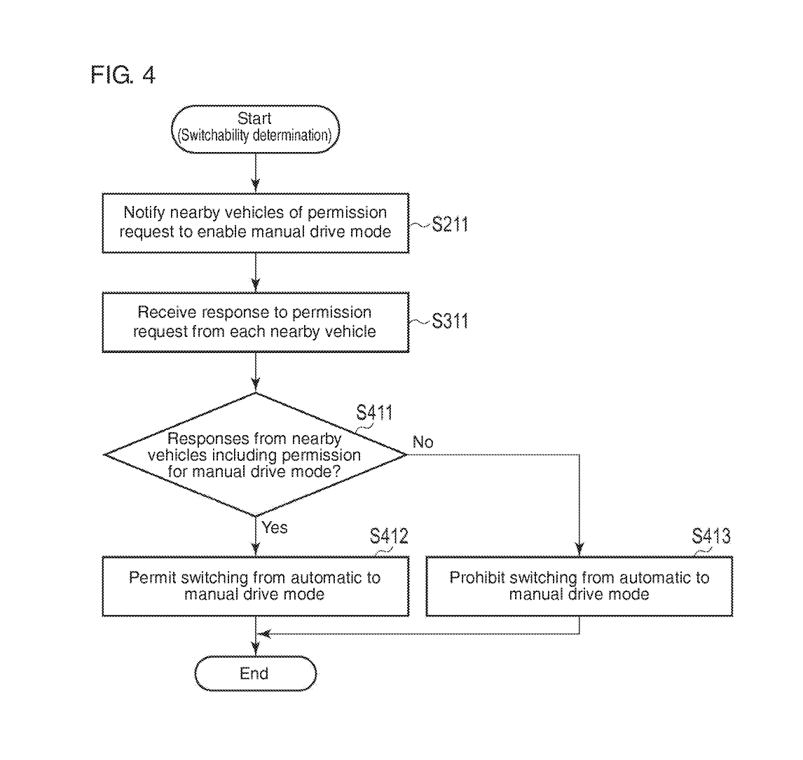

FIG. 4 is a flowchart showing an example of the switching determination performed by the drive switching determination apparatus 2. For example, the vehicle 1 in the automatic drive mode may enter a predetermined area, stop within the predetermined area, switch from the automatic drive mode to the manual drive mode within the predetermined area, and restart in the manual drive mode.

The inter-vehicle information notification unit 2316 notifies each nearby vehicle within the predetermined area of a switch request to enable the manual drive mode in the vehicle 1 through the communication device 17 (step S211). The switch request to enable the manual drive mode may equate to a switch request for switching from the automatic drive mode to the manual drive mode.

Each nearby vehicle transmits a response to this switch request. For example, each nearby vehicle transmits a response including switch permission or switch prohibition based on a predetermined rule. For example, a response including switch permission may be restricted to be transmitted to a single vehicle. The inter-vehicle information obtaining unit 2317 then receives the response from each nearby vehicle (step S311). For example, each nearby vehicle transmits a response including switch permission or switch prohibition based on the timing of the switch request. In some embodiments, each nearby vehicle transmits a response including switch permission or switch prohibition based on the stop times of the vehicle 1 and the nearby vehicles. In some embodiments, each nearby vehicle transmits a response including switch permission or switch prohibition based on the positional information about the vehicle 1 and the nearby vehicles. In some embodiments, each nearby vehicle transmits a response including switch permission or switch prohibition based on the positional information and the traveling directions of the vehicle 1 and the nearby vehicles.

When receiving the response including the switch permission from each nearby vehicle (Yes in step S411), the switching determination unit 2318 determines switching of the vehicle 1 to be permitted from the automatic drive mode to the manual drive mode (step S412). The signal output unit 2319 outputs a signal indicating the permission to switch from the automatic drive mode to the manual drive mode.

In other cases, when receiving the response including the switch prohibition from at least one nearby vehicle (No in step S411), the switching determination unit 2318 determines switching of the vehicle 1 to be prohibited from the automatic drive mode to the manual drive mode (step S413). The signal output unit 2319 outputs a signal indicating the prohibition of switching from the automatic drive mode to the manual drive mode.

For example, the above predetermined rule may include condition 1 for outputting a switch permission to the vehicle with the earliest switch request. For example, the inter-vehicle information notification unit 2316 transmits a switch request including time information. When receiving switch requests from multiple vehicles, the vehicle 1 and the nearby vehicles within the predetermined area detect the earliest switch request based on the time information included in the switch requests. The vehicle 1 and the nearby vehicles each return a response including switch permission to the vehicle with the switch request satisfying condition 1, and a response including switch prohibition to the vehicles with switch requests not satisfying condition 1. The vehicle 1, which has transmitted the switch request satisfying condition 1, will receive the response including the switch permission from each nearby vehicle. In this case, the vehicle 1, which has transmitted the switch request satisfying condition 1, becomes ready to switch from the automatic drive mode to the manual drive mode and start depending on the driver's timing.

The other nearby vehicles within the predetermined area remain in the automatic drive mode. When, for example, the vehicle 1 moves sufficiently away from the nearby vehicles or leaves the predetermined area, the second earliest switch request moves up to the earliest switch request. Thus, the nearby vehicle that has transmitted the switch request satisfying condition 1 second to the vehicle 1 becomes ready to switch from the automatic drive mode to the manual drive mode.

In the example described below, the vehicle 1 transmits a switch request to enable the manual drive mode and each nearby vehicle also transmits a switch request to enable the manual drive mode, or each nearby vehicle receives the request from the vehicle 1 for the permission to enable the manual drive mode and transmits a response including a switch request to enable the manual drive mode to the vehicle 1. In this case, the inter-vehicle information obtaining unit 2317 in the vehicle 1 obtains these responses, and the switching determination unit 2318 in the vehicle 1 permits switching from the automatic drive mode to the manual drive mode in the vehicle 1 based on the timing of the switch request from the vehicle 1 and the timing of the switch request from each nearby vehicle. For example, the switching determination unit 2318 in the vehicle 1 permits switching from the automatic drive mode to the manual drive mode in the vehicle 1 based on the timing of the switch request from the vehicle 1 being the earliest of the switch requests. In other cases, the switching determination unit 2318 does not permit the switching based on the timing being not earliest.

For example, the switching determination unit 2318 determines the priority of switching from the automatic drive mode to the manual drive mode in the vehicle 1 based on the timing (time) of the switch request from the vehicle 1 and the timing (time) of the switch request from nearby vehicles. The switching determination unit 2318 also determines the priority of switching from the automatic drive mode to the manual drive mode in each nearby vehicle based on the responses from the nearby vehicles. More specifically, the switching determination unit 2318 assigns the highest priority to the vehicle 1 or a nearby vehicle that has output the earliest switch request, and the second highest priority to the vehicle 1 or a nearby vehicle that has output the second earliest switch request. The switching determination unit 2318 determines whether to permit switching the vehicle 1 from the automatic drive mode to the manual drive mode based on the comparison between the switching priority of the vehicle 1 and the switching priority of each nearby vehicle. More specifically, the switching determination unit 2318 permits switching the vehicle 1 from the automatic drive mode to the manual drive mode when the vehicle 1 has the highest switching priority. In contrast, the switching determination unit 2318 does not permit switching the vehicle 1 from the automatic drive mode to the manual drive mode when any nearby vehicle has the highest switching priority.

In some embodiments, the above predetermined rule may include condition 2 for outputting switch permission to the vehicle that stops earliest within the predetermined area. Under condition 2, switch permission may also be output to vehicles in the order in which they stop within the predetermined area. For example, the inter-vehicle information notification unit 2316 transmits a switch request including the stop time at which the vehicle 1 stops within the predetermined area. When receiving switch requests from multiple vehicles, the vehicle 1 and the nearby vehicles detect the vehicle that has stopped earliest within the predetermined area based on the stop times included in the switch requests. The nearby vehicles each return a response including switch permission to the vehicle 1 with the switch request satisfying condition 2. The vehicle 1 and the nearby vehicles each return a response including switch prohibition to the vehicles with the switch requests not satisfying condition 2. The vehicle 1 with the switch request satisfying condition 2 will thus receive the response including the switch permission from each nearby vehicle. In this case, the vehicle 1 with the switch request satisfying condition 2 becomes ready to switch from the automatic drive mode to the manual drive mode and start depending on the driver's timing.

The other nearby vehicles within the predetermined area remain in the automatic drive mode. When, for example, the vehicle 1 moves sufficiently away from the nearby vehicles or leaves the predetermined area, the nearby vehicle with the switch request satisfying condition 2 second to the vehicle 1 receives responses including the switch permission from the remaining nearby vehicles. Thus, the nearby vehicle satisfying condition 2 second to the vehicle 1 becomes ready to switch from the automatic drive mode to the manual drive mode.

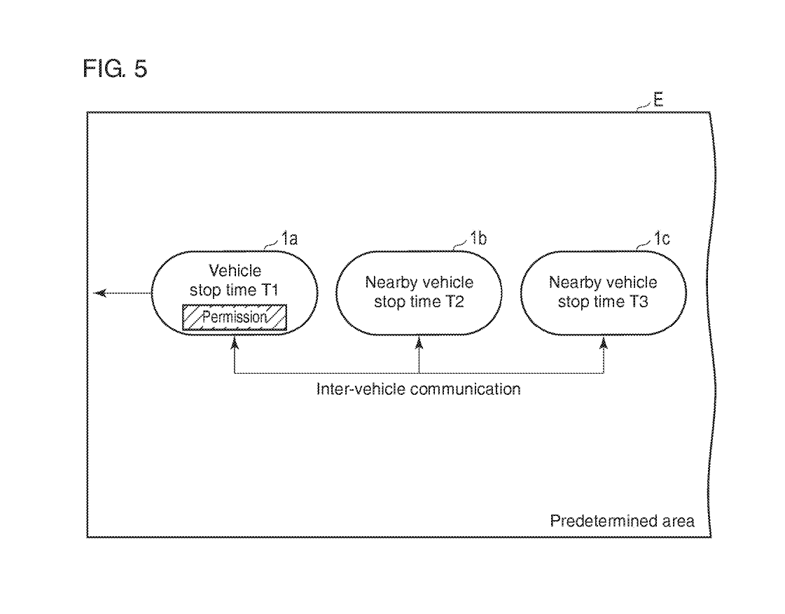

For example, as shown in FIG. 5, vehicles 1a, 1b, and 1c may stop within a predetermined area E, and the vehicles 1a, 1b, and 1c may have inter-vehicle communication. In this example, the vehicle 1a has a stop time T1, the vehicle 1b behind has a stop time T2, and the vehicle 1c further behind has a stop time T3. The stop time T1 is the earliest, the stop time T2 is the second earliest, and the stop time T3 is the latest. In this case, in response to a switch request from the vehicle 1a, the vehicles 1b and 1c notify the vehicle 1a of switch permission. After that, the vehicle 1b will receive a switch request. For example, after the vehicles 1a and 1b leave the predetermined area E, the vehicle 1c may detect no other vehicle within the predetermined area E, thus allowed to switch from the automatic drive mode to the manual drive mode.

In the example described below, the vehicle 1 transmits a switch request to enable the manual drive mode, and each nearby vehicle receives the request from the vehicle 1 for the permission to enable the manual drive mode and transmits a response including its stop time to the vehicle 1. In this case, the inter-vehicle information obtaining unit 2317 in the vehicle 1 obtains these responses, and the switching determination unit 2318 in the vehicle 1 permits switching from the automatic drive mode to the manual drive mode in the vehicle 1 based on the stop time of the vehicle 1 and the stop time of nearby vehicles. For example, the switching determination unit 2318 in the vehicle 1 permits switching from the automatic drive mode to the manual drive mode in the vehicle 1 based on the stop time of the vehicle 1 being the earliest. The request from the vehicle 1 for the permission to enable the manual drive mode may or may not include the stop time of the vehicle 1.

For example, the switching determination unit 2318 determines the priority of switching from the automatic drive mode to the manual drive mode in the vehicle 1 based on the stop time of the vehicle 1 and the stop time of nearby vehicles. The switching determination unit 2318 also determines the priority of switching from the automatic drive mode to the manual drive mode in each nearby vehicle based on the responses from the nearby vehicles. More specifically, the switching determination unit 2318 assigns the highest priority to the vehicle 1 or a nearby vehicle having the earliest stop time, and the second highest priority to the vehicle 1 or a nearby vehicle having the second earliest stop time. The switching determination unit 2318 determines whether to permit switching the vehicle 1 from the automatic drive mode to the manual drive mode based on the comparison between the switching priority of the vehicle 1 and the switching priority of each nearby vehicle. More specifically, the switching determination unit 2318 permits switching the vehicle 1 from the automatic drive mode to the manual drive mode when the vehicle 1 has the highest switching priority. In contrast, the switching determination unit 2318 does not permit switching the vehicle 1 from the automatic drive mode to the manual drive mode when any nearby vehicle has the highest switching priority.

In some embodiments, the above predetermined rule may include condition 3 for outputting switch permission to the vehicle nearest a reference position (e.g., adjacent to an exit) within the predetermined area. For example, the map information in the navigation system 13 may include the predetermined area and also the reference position in the predetermined area. For example, the inter-vehicle information notification unit 2316 transmits a switch request including the positional information about the vehicle 1 within the predetermined area. When receiving switch requests from multiple vehicles, the vehicle 1 and the nearby vehicles detect the vehicle nearest the reference position based on the positional information included in the switch requests. The nearby vehicles each return a response including switch permission to the vehicle 1 with the switch request satisfying condition 3. The vehicle 1 and the nearby vehicles each return a response including switch prohibition to the vehicles with the switch requests not satisfying condition 3. The vehicle 1 satisfying condition 3 will thus receive the response including the switch permission from each nearby vehicle. In this case, the vehicle 1 satisfying condition 3 becomes ready to switch from the automatic drive mode to the manual drive mode and start depending on the driver's timing.

The other nearby vehicles within the predetermined area remain in the automatic drive mode. When, for example, the vehicle 1 moves sufficiently away from the nearby vehicles or leaves the predetermined area, the switch request from the nearby vehicle satisfying condition 3 second to the vehicle 1 receives responses including the switch permission from the remaining nearby vehicles. Thus, the nearby vehicle satisfying condition 3 second to the vehicle 1 becomes ready to switch from the automatic drive mode to the manual drive mode.

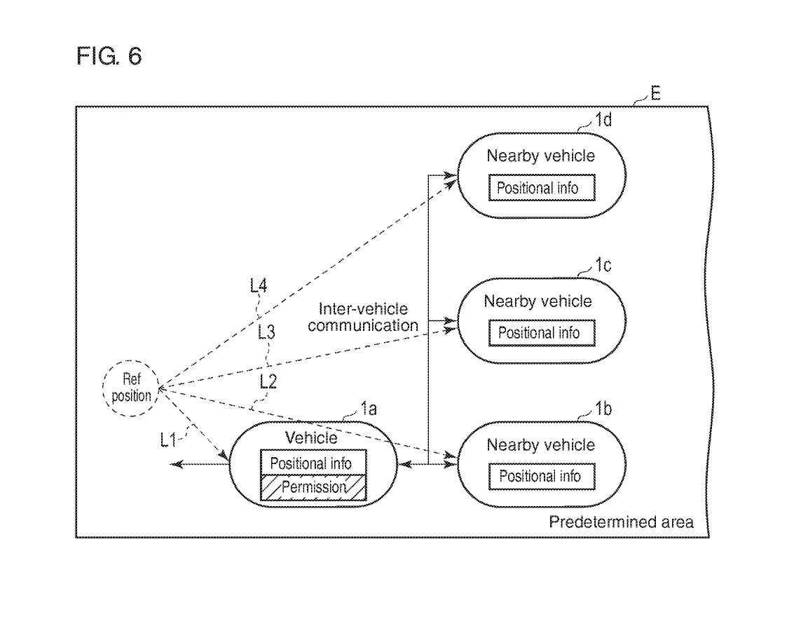

For example, as shown in FIG. 6, vehicles 1a, 1b, 1c, and 1d may stop within a predetermined area E, and the vehicles 1a, 1b, 1c, and 1d may have inter-vehicle communication. The vehicle 1a has a distance L1 from a reference position, the vehicle 1b has a distance L2 from the reference position, the vehicle 1c has a distance L3 from the reference position, and the vehicle 1d has a distance L4 from the reference position. The distance L1 is the shortest, the distance L2 is the second shortest, the distance L3 is the third shortest, and the distance L4 is the longest. In this case, in response to a switch request from the vehicle 1a, the vehicles 1b, 1c, and 1d notify the vehicle 1a of switch permission. After that, the vehicles 1b and 1c will receive a switch request in this order. For example, after the vehicles 1a, 1b, and 1c leave the predetermined area E, the vehicle 1d may detect no other vehicle within the predetermined area E, thus allowed to switch from the automatic drive mode to the manual drive mode.

In the example described below, the vehicle 1 transmits a switch request to enable the manual drive mode, and each nearby vehicle receives the request from the vehicle 1 for the permission to enable the manual drive mode and transmits a response including its positional information to the vehicle 1. In this case, the inter-vehicle information obtaining unit 2317 in the vehicle 1 obtains these responses, and the switching determination unit 2318 in the vehicle 1 permits switching from the automatic drive mode to the manual drive mode in the vehicle 1 based on the positional information about the vehicle 1 and the positional information about nearby vehicles. For example, the switching determination unit 2318 in the vehicle 1 permits switching from the automatic drive mode to the manual drive mode in the vehicle 1 based on the vehicle 1 being nearest the reference position. The request from the vehicle 1 for the permission to enable the manual drive mode may or may not include the positional information about the vehicle 1.

For example, the switching determination unit 2318 determines the priority of switching from the automatic drive mode to the manual drive mode in the vehicle 1 based on the positional information about the vehicle 1 and the positional information about nearby vehicles. The switching determination unit 2318 also determines the priority of switching from the automatic drive mode to the manual drive mode in each nearby vehicle based on the responses from the nearby vehicles. More specifically, the switching determination unit 2318 assigns the highest priority to the vehicle 1 or a nearby vehicle nearest the reference position, and the second highest priority to the vehicle 1 or a nearby vehicle second nearest the reference position. The switching determination unit 2318 determines whether to permit switching the vehicle 1 from the automatic drive mode to the manual drive mode based on the comparison between the switching priority of the vehicle 1 and the switching priority of each nearby vehicle. More specifically, the switching determination unit 2318 permits switching the vehicle 1 from the automatic drive mode to the manual drive mode when the vehicle 1 has the highest switching priority. In contrast, the switching determination unit 2318 does not permit switching the vehicle 1 from the automatic drive mode to the manual drive mode when any nearby vehicle has the highest switching priority.

In some embodiments, the above predetermined rule may include condition 4 for outputting switch permission to the vehicle with no other vehicles ahead in the traveling direction and nearest a reference position within the predetermined area. For example, the inter-vehicle information notification unit 2316 transmits a switch request including the positional information and the traveling direction of the vehicle 1 within the predetermined area. When receiving switch requests from multiple vehicles, the vehicle 1 and the nearby vehicles detect the vehicle having no other vehicles ahead in the traveling direction and being nearest the reference position based on the positional information and the traveling direction included in the switch requests. The nearby vehicles each return a response including switch permission to the vehicle 1 with the switch request satisfying condition 4. The vehicle 1 and the nearby vehicles each return a response including switch prohibition to the vehicles with the switch requests not satisfying condition 4. The vehicle 1 satisfying condition 4 will thus receive the response including the switch permission from each nearby vehicle. In this case, the vehicle 1 satisfying condition 4 becomes ready to switch from the automatic drive mode to the manual drive mode and start depending on the driver's timing.

The other nearby vehicles within the predetermined area remain in the automatic drive mode. When, for example, the vehicle 1 moves sufficiently away from the nearby vehicles or leaves the predetermined area, the switch request from the nearby vehicle satisfying condition 4 second to the vehicle 1 receives responses including the switch permission from the remaining nearby vehicles. Thus, the nearby vehicle satisfying condition 4 second to the vehicle 1 becomes ready to switch from the automatic drive mode to the manual drive mode.

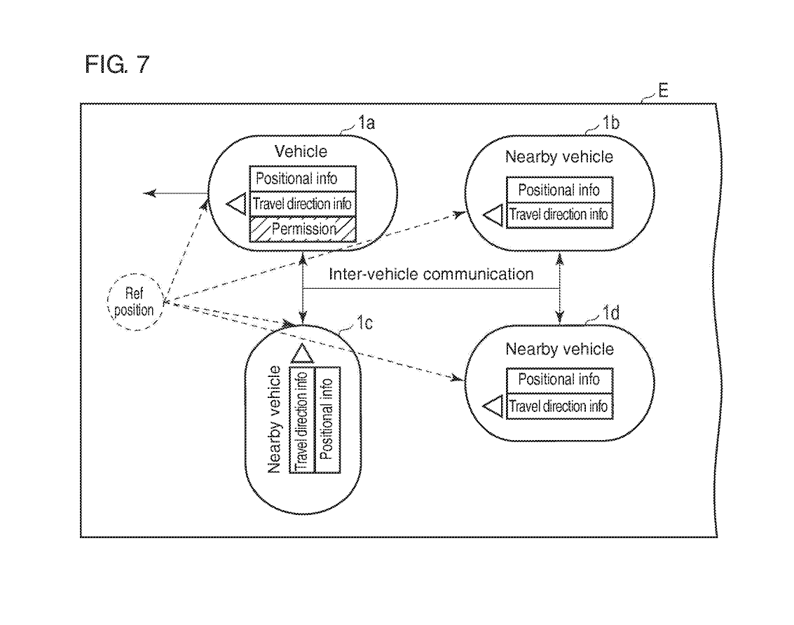

For example, as shown in FIG. 7, vehicles 1a, 1b, 1c, and 1d may stop within a predetermined area E, and the vehicles 1a, 1b, 1c, and 1d may have inter-vehicle communication. The vehicle 1a has no other vehicles ahead in the traveling direction and is nearest a reference position within the predetermined area E. In this case, in response to a switch request from the vehicle 1a, the vehicles 1b, 1c, and 1d notify the vehicle 1a of switch permission. After that, the vehicles 1b and 1c will receive a switch request in this order. For example, after the vehicles 1a, 1b, and 1c leave the predetermined area E, the vehicle 1d may detect no other vehicle within the predetermined area E, thus allowed to switch from the automatic drive mode to the manual drive mode.

In the example described below, the vehicle 1 transmits a switch request to enable the manual drive mode, and each nearby vehicle receives the request from the vehicle 1 for the permission to enable the manual drive mode and transmits a response including its positional information and traveling direction to the vehicle 1. In this case, the inter-vehicle information obtaining unit 2317 in the vehicle 1 obtains these responses, and the switching determination unit 2318 in the vehicle 1 permits switching the vehicle 1 from the automatic drive mode to the manual drive mode based on the positional information and the traveling directions of the vehicle 1 and nearby vehicles. For example, the switching determination unit 2318 in the vehicle 1 permits switching from the automatic drive mode to the manual drive mode in the vehicle 1 based on the vehicle 1 having no other vehicles ahead in the traveling direction and nearest the reference position. The request from the vehicle 1 for the permission to enable the manual drive mode may or may not include the positional information and the traveling direction of the vehicle 1.

For example, the switching determination unit 2318 determines the priority of switching from the automatic drive mode to the manual drive mode in the vehicle 1 based on the positional information and the traveling directions of the vehicle 1 and nearby vehicles. The switching determination unit 2318 also determines the priority of switching from the automatic drive mode to the manual drive mode in each nearby vehicle based on the responses from the nearby vehicles. More specifically, the switching determination unit 2318 assigns the highest priority to the vehicle 1 or a nearby vehicle having no vehicles ahead in the traveling direction and nearest the reference position, and the second highest priority to the vehicle 1 or a nearby vehicle having no vehicles ahead in the traveling direction and second nearest the reference position. The switching determination unit 2318 determines whether to permit switching the vehicle 1 from the automatic drive mode to the manual drive mode based on the comparison between the switching priority of the vehicle 1 and the switching priority of each nearby vehicle. More specifically, the switching determination unit 2318 permits switching the vehicle 1 from the automatic drive mode to the manual drive mode when the vehicle 1 has the highest switching priority. In contrast, the switching determination unit 2318 does not permit switching the vehicle 1 from the automatic drive mode to the manual drive mode when any nearby vehicle has the highest switching priority.

In these examples, the vehicle 1 notifies each nearby vehicle of a switch request, and the vehicle 1 obtains responses from the nearby vehicles. However, a first nearby vehicle may notify the vehicle 1 and the remaining nearby vehicles of a switch request, and the first nearby vehicle may obtain responses from the vehicle 1 and the remaining nearby vehicles.

As described above, the switch request to enable the manual drive mode may equate to a switch request for switching from the automatic drive mode to the manual drive mode in the vehicle 1. The request may also equate to a switch request output when the vehicle 1 stops within the predetermined area and enables the manual drive mode in a neutral state other than the automatic drive mode and the manual drive mode. For example, the predetermined area may be included in a service area or a parking area on an expressway or other toll roads. The driver may park the vehicle 1 within the predetermined area and stop the engine. In some embodiments, the driver may leave the vehicle 1. The driver may later restart the engine of the vehicle 1 and enables the manual drive mode. In this example, the manual drive mode is enabled in the neutral state.

### Effects

In one or more embodiments, the drive switching determination apparatus 2 communicates with one or more nearby vehicles within the predetermined area to notify each nearby vehicle of a switch request to enable the manual drive mode. When obtaining a response including permission to enable the manual drive mode from each nearby vehicle, the drive switching determination apparatus 2 permits switching from the automatic drive mode to the manual drive mode. For example, a vehicle that receives a switch request to enable the manual drive mode may be restricted to transmit a response including switch permission to a single vehicle. The vehicle that has obtained the switch permission from each nearby vehicle within the predetermined area becomes ready to switch from the automatic drive mode to the manual drive mode and start depending on the driver's timing. The vehicles that have obtained no switch permission from each nearby vehicle within the predetermined area are not yet ready to enable the manual drive mode. Such switching determination allows smooth vehicle traveling and achieves safety within the predetermined area. For example, vehicles within a predetermined area are prevented from switching from the automatic drive mode to the manual drive mode depending on their timing and starting depending on their timing.

For example, the manual drive mode is permitted based on the timing of a switch request to enable the manual drive mode from each vehicle within the predetermined area. For example, the vehicle with the earliest request for switch permission may receive the switch permission. The vehicle that has transmitted the earliest request for switch permission within the predetermined area is ready to switch from the automatic drive mode to the manual drive mode and start depending on the driver's timing. The vehicles that have obtained no switch permission within the predetermined area are not yet ready to enable the manual drive mode. Such switching determination allows smooth vehicle traveling and achieves safety within the predetermined area.

For example, the manual drive mode is permitted based on the stop time of each vehicle within the predetermined area. For example, the vehicle that has stopped earliest may receive the switch permission. The vehicle that has stopped earliest within the predetermined area is ready to switch from the automatic drive mode to the manual drive mode and start depending on the driver's timing. The vehicles that have obtained no switch permission within the predetermined area are not yet ready to enable the manual drive mode. Such switching determination allows smooth vehicle traveling and achieves safety within the predetermined area.

For example, the manual drive mode is permitted based on the positional information about each vehicle within the predetermined area. For example, the vehicle nearest a reference position within the predetermined area may receive the switch permission. The vehicle nearest the reference position within the predetermined area is ready to switch from the automatic drive mode to the manual drive mode and start depending on the driver's timing. The vehicles that have obtained no switch permission within the predetermined area are not yet ready to enable the manual drive mode. Such switching determination allows smooth vehicle traveling and achieves safety within the predetermined area.

For example, the manual drive mode is permitted based on the positional information and the traveling direction of each vehicle within the predetermined area. For example, the vehicle having no vehicles ahead in the traveling direction and nearest a reference position within the predetermined area may receive the switch permission. The vehicle having no vehicles ahead in the traveling direction and nearest the reference position within the predetermined area is ready to switch from the automatic drive mode to the manual drive mode and start depending on the driver's timing. The vehicles that have obtained no switch permission within the predetermined area are not yet ready to enable the manual drive mode. Such switching determination allows smooth vehicle traveling and achieves safety within the predetermined area.

For example, any vehicle having no switch permission within the predetermined area is not yet ready to enable the manual drive mode, and waits for switching to the manual drive mode. Thus, this vehicle cannot start depending on the driver's timing. This allows smooth vehicle traveling and achieves safety within the predetermined area.

In some embodiments, the drive switching determination apparatus 2 in the vehicle 1 communicates with one or more nearby vehicles within the predetermined area to notify each nearby vehicle of a switch request to enable the manual drive mode. When receiving a switch request to enable the manual drive mode from each nearby vehicle, the drive switching determination apparatus 2 in the vehicle 1 permits switching from the automatic drive mode to the manual drive mode based on the switch request from the vehicle 1 and the switch request from each nearby vehicle. For example, when the vehicle 1 outputs the switch request earliest (time), the drive switching determination apparatus 2 permits the vehicle 1 to switch from the automatic drive mode to the manual drive mode. When any nearby vehicle outputs the switch request earliest (time), the drive switching determination apparatus 2 permits the nearby vehicle to switch from the automatic drive mode to the manual drive mode, and does not permit the vehicle 1 to switch from the automatic drive mode to the manual drive mode. Such switching determination allows smooth vehicle traveling and achieves safety within the predetermined area.

In some embodiments, the drive switching determination apparatus 2 in the vehicle 1 communicates with one or more nearby vehicles within the predetermined area to notify each nearby vehicle of a switch request to enable the manual drive mode. When receiving a stop time from each nearby vehicle, the drive switching determination apparatus 2 in the vehicle 1 permits switching from the automatic drive mode to the manual drive mode based on the stop time from the vehicle 1 and the stop time from each nearby vehicle. For example, when the vehicle 1 has the earliest stop time, the drive switching determination apparatus 2 permits the vehicle 1 to switch from the automatic drive mode to the manual drive mode. When any nearby vehicle has the earliest stop time, the drive switching determination apparatus 2 permits the nearby vehicle to switch from the automatic drive mode to the manual drive mode in the nearby vehicle, and does not permit the vehicle 1 to switch from the automatic drive mode to the manual drive mode. Such switching determination allows smooth vehicle traveling and achieves safety within the predetermined area.

In some embodiments, the drive switching determination apparatus 2 in the vehicle 1 communicates with one or more nearby vehicles within the predetermined area to notify each nearby vehicle of a switch request to enable the manual drive mode. When receiving positional information from each nearby vehicle, the drive switching determination apparatus 2 in the vehicle 1 permits switching from the automatic drive mode to the manual drive mode based on the positional information about the vehicle 1 and the positional information about each nearby vehicle. For example, when the vehicle 1 is nearest a reference position within the predetermined area based on the positional information about the vehicle 1, the drive switching determination apparatus 2 permits the vehicle 1 to switch from the automatic drive mode to the manual drive mode. When any nearby vehicle is nearest the reference position within the predetermined area based on the positional information about the predetermined vehicle, the drive switching determination apparatus 2 permits the nearby vehicle to switch from the automatic drive mode to the manual drive mode, and does not permit the vehicle 1 to switch from the automatic drive mode to the manual drive. Such switching determination allows smooth vehicle traveling and achieves safety within the predetermined area.

In some embodiments, the drive switching determination apparatus 2 in the vehicle 1 communicates with one or more nearby vehicles within the predetermined area to notify each nearby vehicle of a switch request to enable the manual drive mode. When receiving positional information and a traveling direction from each nearby vehicle, the drive switching determination apparatus 2 in the vehicle 1 permits switching from the automatic drive mode to the manual drive mode based on the positional information and the traveling directions of the vehicle 1 and each nearby vehicle. For example, when the vehicle 1 has no vehicles ahead in the traveling direction and is nearest a reference position within the predetermined area based on the positional information and the traveling direction of the vehicle 1, the drive switching determination apparatus 2 permits the vehicle 1 to switch from the automatic drive mode to the manual drive mode. When any nearby vehicle has no vehicles ahead in the traveling direction and is nearest the reference position within the predetermined area based on the positional information, the drive switching determination apparatus 2 permits the nearby vehicle to switch from the automatic drive mode to the manual drive mode, and does not permit the vehicle 1 to switch from the automatic drive mode to the manual drive mode. Such switching determination allows smooth vehicle traveling and achieves safety within the predetermined area.

### Other Embodiments

Some other embodiments will now be described. For example, a vehicle may stop at an intersection and switch from the automatic drive mode to the manual drive mode. In this case, the drive switching determination apparatus 2 may determine the above drive switching for a predetermined area including the intersection. The drive switching determination apparatus 2 may also define the above reference position within the predetermined area based on the positional information and the traveling direction of the vehicle. This allows smooth vehicle traveling and achieves safety at the intersection.

In some embodiments, a vehicle may stop at an intersection or any other position and switch from the automatic drive mode to the manual drive mode. In this case, the drive switching determination apparatus 2 defines a predetermined area with respect to the vehicle stop position based on the map data in the navigation system 13 and the current positional information. The drive switching determination apparatus 2 may also define the above reference position within the predetermined area based on the positional information and the traveling direction of the vehicle. In this case, the drive switching determination apparatus 2 may determine the above drive switching for the defined predetermined area.

With any vehicle in the manual drive mode among multiple vehicles within the predetermined area, the other vehicles in the automatic drive mode may remain stopped until the vehicle in the manual drive mode leaves the predetermined area. This allows smooth vehicle traveling and achieves safety.

The vehicle 1 within the predetermined area may be allowed to switch from the automatic drive mode to the manual drive mode when receiving switch permission from all the nearby vehicles within the predetermined area or when receiving switch permission or responses (any of switch requests, stop times, positional information, and positional information and traveling directions) from some nearby vehicles within the predetermined area (e.g., every nearby vehicle within a predetermined distance). This switching determination is advantageous for a large predetermined area in which vehicles at different positions are less likely to collide with each other when they start at the same time.

The present invention is not limited to the embodiments described above, but the components may be modified without departing from the spirit and scope of the invention. The components described in the above embodiments may be combined as appropriate to provide various aspects of the invention. For example, some of the components described in each embodiment described above may be eliminated. Further, components in different embodiments may be combined as appropriate.

The above embodiments may be implemented with a storage medium such as a read-only memory (ROM), which stores programs causing the processor 231 to function as units included in the processor 231.

The above embodiments may be partially or entirely expressed in, but not limited to, the following forms shown in the appendixes below.

### APPENDIX 1

A drive switching determination apparatus for a vehicle that communicates with at least one nearby vehicle within a predetermined area, the apparatus comprising a processor and a memory storing instructions for operating the processor, the processor being configured to

notify the at least one nearby vehicle of a switch request to enable a manual drive mode in the vehicle,

obtain a response from the at least one nearby vehicle to the switch request,

permit switching from an automatic drive mode to the manual drive mode in the vehicle based on the response from the at least one nearby vehicle, and

output a signal indicating the switching permission.

### APPENDIX 2

A drive switching determination method for a vehicle that communicates with at least one nearby vehicle within a predetermined area, the method comprising:

notifying, with at least one processor, the at least one nearby vehicle of a switch request to enable a manual drive mode in the vehicle;

obtaining, with the at least one processor, a response from the at least one nearby vehicle to the switch request;

permitting, with the at least one processor, switching from an automatic drive mode to the manual drive mode in the vehicle based on the response from the at least one nearby vehicle; and

outputting, with the at least one processor, a signal indicating the switching permission.

1. A drive switching determination apparatus for a vehicle that communicates with at least one nearby vehicle within a predetermined area, the apparatus comprising a processor configured with a program to perform operations comprising:
operation as an information notification unit configured to notify the at least one nearby vehicle of a switch request to enable a manual drive mode in the vehicle;
operation as an information obtaining unit configured to obtain a response from the at least one nearby vehicle to the switch request;
operation as a switching determination unit configured to permit switching from an automatic drive mode to the manual drive mode in the vehicle based on the response from the at least one nearby vehicle; and
operation as a signal output unit configured to output a signal indicating the permission for switching.

2. The drive switching determination apparatus according to claim 1, wherein
the processor is configured with the program to perform operations comprising operations such that operation as the information obtaining unit is further configured to obtain the response comprising switch permission or switch prohibition of switching from the automatic drive mode to the manual drive mode in the vehicle.

3. The drive switching determination apparatus according to claim 1, wherein the processor is configured with the program to perform operations comprising operations such that:
operation as the information obtaining unit is further configured to obtain the response comprising information about a switch request to enable a manual drive mode in the at least one nearby vehicle, and
operation as the switching determination unit is further configured to permit switching from the automatic drive mode to the manual drive mode in the vehicle based on timing of the switch request from the vehicle and timing of the switch request from the at least one nearby vehicle.

4. The drive switching determination apparatus according to claim 1, wherein the processor is configured with the program to perform operations comprising operations such that:
operation as the information obtaining unit is further configured to obtain the response comprising a stop time of the at least one nearby vehicle that is stopped, and
operation as the switching determination unit is further configured to permit switching from the automatic drive mode to the manual drive mode in the vehicle based on a stop time of the vehicle and the stop time of the at least one nearby vehicle.

5. The drive switching determination apparatus according to claim 1, wherein the processor is configured with the program to perform operations comprising operations such that:
operation as the information obtaining unit is further configured to obtain the response comprising positional information about the at least one nearby vehicle that is stopped, and
operation as the switching determination unit is further configured to permit switching from the automatic drive mode to the manual drive mode in the vehicle based on positional information about the vehicle and the positional information about the at least one nearby vehicle.

6. The drive switching determination apparatus according to claim 1, wherein the processor is configured with the program to perform operations comprising operations such that:
operation as the information obtaining unit is further configured to obtain the response comprising positional information and a traveling direction of the at least one nearby vehicle that is stopped, and
operation as the switching determination unit is further configured to permit switching from the automatic drive mode to the manual drive mode in the vehicle based on positional information and a traveling direction of the vehicle and the positional information and the traveling direction of the at least one nearby vehicle.

7. The drive switching determination apparatus according to claim 3, wherein
the processor is configured with the program to perform operations comprising operations such that operation as the switching determination unit is further configured to determine whether to permit switching from the automatic drive mode to the manual drive mode in the vehicle based on a comparison between a priority of switching from the automatic drive mode to the manual drive mode in the vehicle and a priority of switching from the automatic drive mode to the manual drive mode in the at least one nearby vehicle, where the priority in the at least one nearby vehicle is determined based on the response from the at least one nearby vehicle.

8. The drive switching determination apparatus according to claim 1, wherein
the processor is configured with the program to perform operations comprising operations such that operation as the information notification unit is further configured to transmit the switch request in response to a stop of the vehicle.

9. The drive switching determination apparatus according to claim 1, wherein
the switch request comprises a request for switching from the automatic drive mode to the manual drive mode.

10. The drive switching determination apparatus according to claim 2, wherein
the processor is configured with the program to perform operations comprising operations such that operation as the information notification unit is further configured to transmit the switch request in response to a stop of the vehicle.

11. The drive switching determination apparatus according to claim 2, wherein
the switch request comprises a request for switching from the automatic drive mode to the manual drive mode.

12. The drive switching determination apparatus according to claim 3, wherein
the processor is configured with the program to perform operations comprising operations such that operation as the information notification unit is further configured to transmit the switch request in response to a stop of the vehicle.

13. The drive switching determination apparatus according to claim 3, wherein
the switch request comprises a request for switching from the automatic drive mode to the manual drive mode.

14. The drive switching determination apparatus according to claim 4, wherein
the processor is configured with the program to perform operations comprising operations such that operation as the switching determination unit is further configured to determine whether to permit switching from the automatic drive mode to the manual drive mode in the vehicle based on a comparison between a priority of switching from the automatic drive mode to the manual drive mode in the vehicle and a priority of switching from the automatic drive mode to the manual drive mode in the at least one nearby vehicle, where the priority in the at least one nearby vehicle is determined based on the response from the at least one nearby vehicle.

15. The drive switching determination apparatus according to claim 4, wherein
the processor is configured with the program to perform operations comprising operations such that operation as the information notification unit is further configured to transmit the switch request when the vehicle is stopped.

16. The drive switching determination apparatus according to claim 4, wherein
the switch request comprises a request for switching from the automatic drive mode to the manual drive mode.

17. A drive switching determination method for a vehicle that communicates with at least one nearby vehicle within a predetermined area, the method comprising:
notifying the at least one nearby vehicle of a switch request to enable a manual drive mode in the vehicle;
obtaining a response from the at least one nearby vehicle to the switch request;
determining whether to permit switching from an automatic drive mode to the manual drive mode in the vehicle based on the response from the at least one nearby vehicle; and
outputting a signal indicating the switching permission.

18. A non-transitory computer-readable storage medium storing a program for drive switching determination, which when read and executed, causes a computer to perform operations comprising operations as the drive switching determination apparatus according to claim 1.
